(19) United States
(12) Patent Application Publication
(10) Pub. No.: US 2007/0263257 A1
(43) Pub. Date: Nov. 15, 2007

(54) Hybrid frame rate control method and architecture for a display

(76) Inventor: Feng-Ting Pai, Tao-Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/431,699

(22) Filed: May 11, 2006

(51) Int. Cl. G06K 15/00

(52) U.S. Cl. 358/3.14

(57) ABSTRACT

A hybrid frame rate control method and architecture used in a display are disclosed, in which each dot is divided into a plurality of sub-dots including a large sub-dot and several small sub-dots. Each sub-dot has a predetermined area ration. A scanning signal is transmitted through a scanning line to turn on transistors of the sub-dots. A voltage of a first gray level and a voltage of a second gray level are written into the three sub-dots. The dot displays a third gray level. After corresponding data of an image frame are input to every sub-dot, a temporal dithering technique is used to refresh the corresponding data on the sub-dots several times between displaying the present image frame and inputting the next image frame. Through weighted combination of different levels and mixing of levels in time, the number of colors that can be displayed can be increased and the color depth can be enhanced.

### BACKGROUND OF THE INVENTION

1. Field of the invention

The present invention relates to display technology for a liquid crystal display panel and, more particularly, to improved frame rate control technology used in a display panel.

2. Description of Related art

FIG. 1 is a drawing showing the architecture of a conventional liquid crystal display panel, which comprises several dots, several scan lines 12 and several data lines 14. Each dot can display one of the three primary colors: red, green and blue, and has an active device 10. Every set of the three primary colors forms a pixel. The scan lines 12 are connected to the gates of the active devices 10, and are used to transmit switching signals of the active devices 10. The data lines 14 are connected to the sources of the active devices 10, and are used to transmit input data to the active devices 10. The active devices 10 can control the light transmittance of each dot. Through change of the light transmittance, different ratios of the three primary colors can be achieved to allow the pixels to show various kinds of different colors.

From the point of view of color, a full-color display means each of the three primary colors can be scaled by 256 grayscales. Therefore, the color displaying capability of a liquid crystal display panel is usually represented with the number of grayscales that can be displayed. For instance, a 6-bit panel means each of the three primary colors has 64 (=2⁶) grayscales. A 6-bit panel thus can display 262,144 (=64×64×64) colors. An 8-bit panel means each of the three primary colors has 256 (=2⁸) grayscales. An 8-bit panel thus can display 16,777,216 (=256×256×256) colors. The number of colors that can be displayed by a panel depends on the drive capability of the system. The better the drive capability of the system, the more the number of colors that can be displayed. However, the higher the color depth supported by a drive IC, the larger size of the decoder, and the higher the cost. In order to simultaneously meet the requirements of low cost and high color depth, a dithering technique is commonly adopted, which makes use of the persistence of vision of human eyes to increase the number of colors that can be displayed by a panel. The dithering technique can generally be classified into the following two types:

Spatial dithering: This technique utilizes spatial combinations to display intermediate color tinges, as shown in FIG. 2, where Lₙ and Lₙ₊₁ represent two different color values, respectively. Because the spatial dithering is an operation in space, patterns may easily be produced on the frame and reduce the recognition rate of an image. Moreover, more memory will be consumed. The spatial dithering technique is thus generally used in scalar systems.

Temporal dithering: This technique utilizes an operation in time to instantaneously refresh colors several times. Because of persistence of vision, various kinds of color tinges will be mixed by human eyes to produce new intermediate colors, hence accomplishing the same effect as interpolating, as shown in FIG. 3. Liquid crystal display panels generally adopt this method, which is also called the frame rate control technique.

A general frame rate control technique can increase the color depth by about 2 bits, but can rarely increase the color depth by 3 bits. Therefore, the frame rate control technique provides only a limited assistance in lowering the cost and enhancing the color depth of panel. If one wants to apply the above two dithering techniques to a 6-bit panel to increase its color depth to 10 bits, the size of the architecture will be greatly enlarged, and the timing operations will also become very complicated. In order to improve the prior art, the present invention therefore aims to exchange minimum complexity for color depth, and discloses a hybrid frame rate control technique for a display panel that can support display panels of at least 4-bit color depth.

### SUMMARY OF THE INVENTION

To achieve these and other advantages and in order to overcome the disadvantages of the conventional method in accordance with the purpose of the invention as embodied and broadly described herein, the present invention provides a hybrid frame rate control method used in liquid crystal display panels, which can increase the color depth by 4 bits, and can support panels of at least 4-bit color depth. At the same time of enhancing the color depth, the production cost can also be greatly reduced, and the degree of flickering will become minimized.

An object of the present invention is to provide a dot architecture capable of enhancing the color depth of a panel, in which each dot comprises three sub-dots. Each sub-dot is composed of a scanning line, a data line, and a thin film transistor having a gate electrically connected to the scanning line, a source electrically connected to the data line, and a drain electrically connected to a sub-dot electrode. The three sub-dot electrodes have predetermined area ratios of 2/4, 1/4, and 1/4 respectively. The two sub-dot electrodes with area ratios of 1/4 are arranged on two sides or on one side of the sub-dot electrode with an area ration of 2/4.

Another object of the present invention is to provide a hybrid frame rate control method used in a display that utilizes the above structure. After the dot has been divided into three sub-dots, a scanning signal is transmitted through the scanning line to turn on the transistors of the three sub-dots in one frame. Then a voltage of a first gray level and a voltage of a second gray level are written respectively into the three sub-dot electrodes by the turned on transistors. Finally, a third gray level is displayed by the dot. The third gray level is between the first gray level and the second gray level.

Another object of the present invention is to provide a hybrid frame rate control method that comprises taking a predetermined number of continuous frames as an image period. The dot displays the first gray level and the third gray level in the plurality of frames of the image period. Alternatively, the dot displays the second gray level and the third gray level in the plurality of frames of the image period.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating the architecture of a conventional liquid crystal display panel;

FIG. 2 is a diagram showing the spatial dithering technique in the prior art;

FIG. 3 is a diagram showing the temporal dithering technique in the prior art;

FIG. 4(a) to 4(c) are drawings showing the dot architecture according to different embodiments of the present invention, respectively;

FIG. 5 is a diagram showing how an embodiment of the present invention gets the same effect as interpolating; and

FIG. 6(a) to 6(c) are drawings showing the dot architecture according to different embodiments of the present invention, respectively.

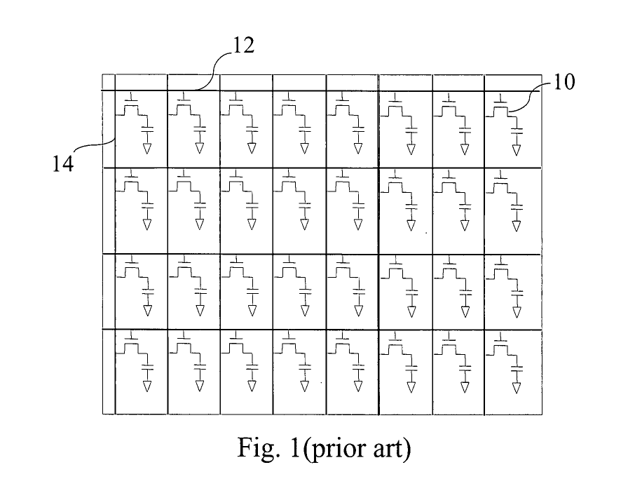

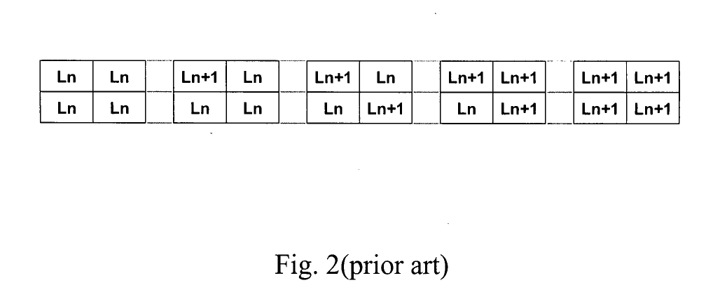

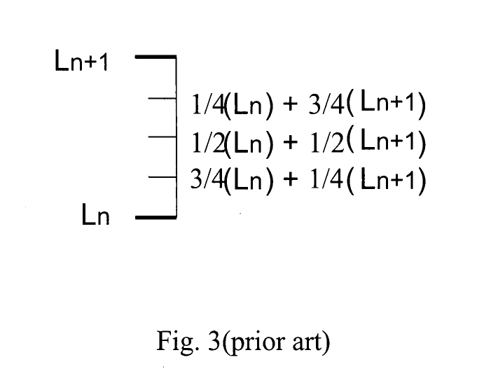

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention provides a hybrid frame rate control method and architecture integrating the spatial domain and time domain. Each dot is divided into three sub-dots, and then integrated with the temporal dithering technique. The area ratio between sub-dots, the gray levels and the technique of temporally refreshing several times are utilized to produce an interpolated new gray level. The present invention can therefore accomplish the maximum color depth with the minimum complexity.

In order to realize the hybrid frame rate control method, the dot architecture has to be modified. In one embodiment, each dot is divided into a large sub-dot and two small sub-dots. Each small sub-dot has an area ratio of 1/4, while the large sub-dot has an area ration of 2/4.

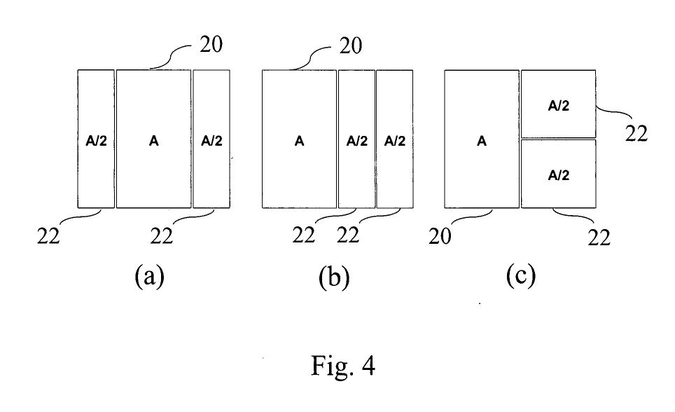

FIG. 4(a) to 4(c) show dot architectures according to different embodiments of the present invention, respectively, where A represents the area ratio. As shown in FIG. 4, the area of the large sub-dot 20 is a half of that of the dot. Because two small sub-dots 22 equally share the remaining space, the area of the small sub-dot 22 is half of that of the large sub-dot 20. The small sub-dots 22 can be arranged at the left and right sides of the large sub-dot 20, as shown in FIG. 4(a), or can be arranged on the same side of the large sub-dot 20, as shown in FIGS. 4(b) and 4(c).

Because the large sub-dot 20 and the small sub-dot 22 have different areas, under the condition of inputting the same data (i.e., color values or grayscale values), the displayed brightness will be different. Through this area ratio (i.e., brightness ratio) and variation of input data, we can get the same effect as interpolating.

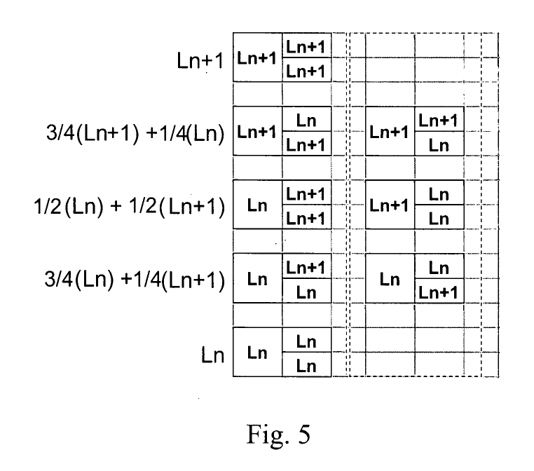

FIG. 5 is a diagram showing how an embodiment of the present invention gets the same effect as interpolating, which is exemplified with the dot architecture shown in FIG. 4(c), where Lₙ and Lₙ₊₁ represent two different gray levels. When the large sub-dot 20 and the two small sub-dots 22 display Lₙ, the displayed color of the whole dot is Lₙ. When the large sub-dot 20 and one small sub-dot 22 display Lₙ and the other small dot 22 displays Lₙ₊₁, the displayed gray level of the whole dot is 3/4(Lₙ)+1/4(Lₙ₊₁).

When writing the voltage of the first gray level Lₙ into the two small sub-dot electrodes with area ratios of 1/4 and writing the voltage of the second gray level Lₙ₊₁ into the large sub-dot with an area ration of 2/4, the dot displays the third gray level Lₓ equal to 1/2(Lₙ)+1/2(Lₙ₊₁).

When writing the value of the first gray level Lₙ into the sub-dot electrode with an area ration of 1/4, and writing the voltage of the second gray level Lₙ₊₁ into the two sub-dot electrodes with area ratios of 1/4 and 2/4, the dot displays the third gray level Lₓ equal to 1/4(Lₙ)+3/4(Lₙ₊₁).

Continuing in this manner, the dot architecture of the present invention can effectively increase the color depth by 2 bits to make the colors that can be displayed more plentiful without enlarging the memory architecture as in the prior art.

If the color depth is needed to be further increased by 2 bits, we can integrate the temporal dithering technique after inputting gray levels corresponding to an image to be displayed to every sub-dot 20 and 22. The corresponding gray levels of the sub-dots 20 and 22 are refreshed several times between displaying the present image frame and inputting the next image frame to mix the color tinges in time. The same effect as interpolating can thus be accomplished by mixing the corresponding data according to the area ratio between the sub-dots and in time. The grayscale operation no longer utilizes the color depth of the conventional dot architecture (i.e., n-bit) as the base, but utilizes (n+2)-bit as the base. Through integration of dot architecture modification and operation in time, the hybrid frame rate control method of the present invention can achieve a color depth of (n+2+2) bits. Therefore, for a 6-bit system, we can get excellent image quality with a 10-bit color depth. Moreover, the degree of the flicking phenomenon accompanying the temporal dithering can also become small due to enhanced color depth. Of course, a blurring step can also be used to suppress the residual flickering phenomenon.

The hybrid frame rate control method of the present invention takes a predetermined number of continuous frames as an image period. Then the first gray level Lₙ and the third gray level Lₓ are displayed by the dot respectively in the plurality of frames of the image period.

In an embodiment of the present invention the image period has four continuous frames and the dot randomly displays the first gray level Lₙ in one frame of the image period and displays the third gray level Lₓ in three frames of the image period. In another embodiment the dot randomly displays the first gray level Lₙ in two frames of the image period and displays the third gray level Lₓ in two frames of the image period. In another embodiment the dot randomly displays the first gray level Lₙ in three frames of the image period and displays the third gray level Lₓ in one frame of the image period.

Similarly, in an embodiment of the present invention a predetermined number of continuous frames are taken as an image period. The dot displays the second gray level Lₙ₊₁ and the third gray level Lₓ in the plurality of frames of the image period.

In an embodiment of the present invention the image period has four continuous frames and the dot randomly displays the second gray level Lₙ₊₁ in one frame of the image period and displays the third gray level Lₓ in three frames of the image period. In another embodiment the dot randomly displays the second gray level Lₙ₊₁ in two frames of the image period and displays the third gray level Lₓ in two frames of the image period. In another embodiment the dot randomly displays the second gray level Lₙ₊₁ in three frames of the image period and displays the third gray level Lₓ in one frame of the image period.

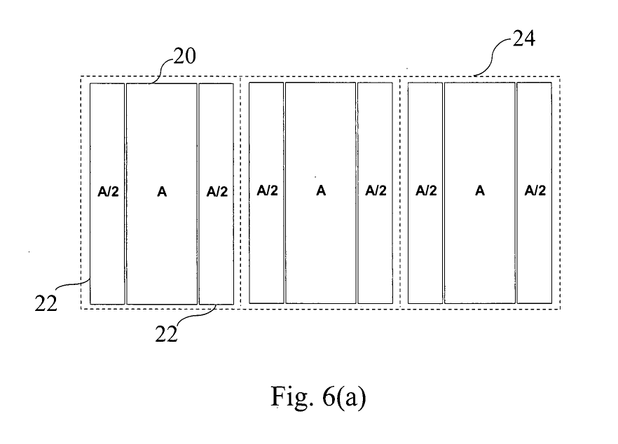

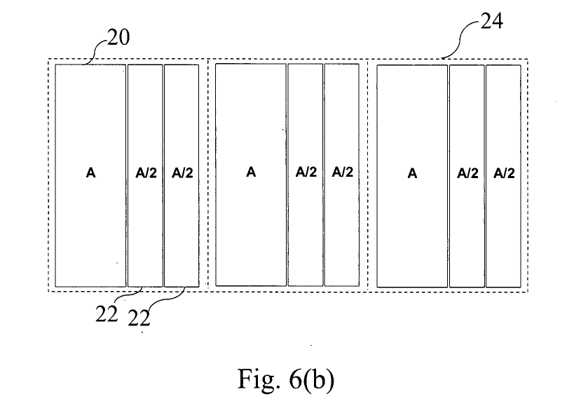

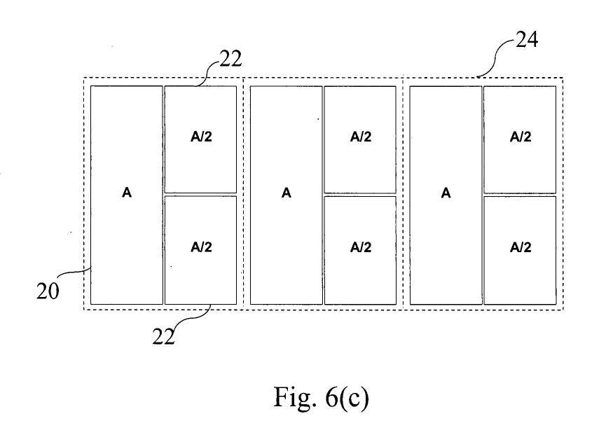

FIG. 6(a) to 6(c) show dot architectures according to different embodiments of the present invention, respectively. As shown in FIG. 6, each dot 24 is divided into a large sub-dot 20 and several small sub-dots 22 equally sharing the remaining space, where A represents the area ratio. In these embodiments, the area of the large sub-dot 20 is half that of the dot 24, and the area of the small sub-dot 22 is half that of the large sub-dot 20. The small sub-dots 22 can be arranged on the left and right sides of the large sub-dot 20, as shown in FIG. 6(a), or can be arranged on the same side of the large sub-dot 20, as shown in FIGS. 6(b) and 6(c). Each sub-dot 20 or 22 can display different gray levels depending on the dot 24 where it is located. Through the area ratio of sub-dots and variation of input data, we can get the same effect as interpolating. Therefore, through the combination of different colors and different levels, the number of colors that can be displayed by each dot 24 can be increased, thereby enhancing the color depth. For example, the dot architectures shown in FIG. 6(a) to FIG. 6(c) can increase the color depth by 2 bits.

Similarly, when applying the above dot architecture to the hybrid frame rate control method of the present invention, after dividing dots into a plurality of sub-dots, data corresponding to an image to be displayed are input to every sub-dot, and the corresponding data on the sub-dots are refreshed several times by means of the temporal dithering technique between displaying the present image frame and inputting the next image frame, thereby getting the same effect as interpolating. The input data are gray levels or grayscale values. The grayscale operation similarly utilizes (n+2)-bit as the base. All the above embodiments can exchange minimum complexity for an enhanced color depth. The present invention not only can increase the color depth by 4 bits and support panels with at least 4-bit color depth, but can also greatly reduce the production cost. Moreover, the degree of the flickering phenomenon can become minimal.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A hybrid frame rate control method used in a display comprising the steps of:
dividing one dot into three sub-dots;
transmitting a scanning signal to turn on transistors of the three sub-dots in one frame;
writing a voltage of first gray level Lₙ and a voltage of second gray level Lₙ₊₁ respectively into three sub-dot electrodes by the turned-on transistors; and
displaying third gray level Lₓ by the dot, and the third gray level Lₓ is between the first gray level Lₙ and the second gray level Lₙ₊₁.

2. The hybrid frame rate control method used in a display as claimed in claim 1, each sub-dot comprising:
a scanning line;
a data line; and
the transistor, the transistor comprising:
a gate electrically connected to the scanning line;
a source electrically connected to the data line; and
a drain electrically connected to the sub-dot electrode, wherein the three sub-dot electrodes have predetermined area ratios.

3. The hybrid frame rate control method used in a display as claimed in claim 2, wherein the three sub-dot electrodes respectively have an area ratio of 2/4, 1/4, and 1/4.

4. The hybrid frame rate control method used in a display as claimed in claim 3, when writing the voltage of first gray level Lₙ into the two sub-dot electrodes with area ratios of 2/4 and 1/4, and writing the voltage of second gray level Lₙ₊₁ into the sub-dot electrode with an area ratio of 1/4, the dot displays the third gray level Lₓ=3/4(Lₙ)+1/4(Lₙ₊₁).

5. The hybrid frame rate control method used in a display as claimed in claim 3, when writing the voltage of first gray level Lₙ into the two sub-dot electrodes with area ratios of 1/4 and 1/4, and writing the voltage of second gray level Lₙ₊₁ into the sub-dot electrode with area ratio of 2/4, the dot displays the third gray level Lₓ=1/2(Lₙ)+1/2(Lₙ₊₁).

6. The hybrid frame rate control method used in a display as claimed in claim 3, when writing the voltage of first gray level Lₙ into the sub-dot electrode with area ratio of 1/4, and writing the voltage of second gray level Lₙ₊₁ into the two sub-dot electrodes with area ratios of 1/4 and 2/4, the dot displays the third gray level Lₓ=1/4(Lₙ)+3/4(Lₙ₊₁).

7. The hybrid frame rate control method used in a display as claimed in claim 1 further comprising the step of:
taking a predetermined number of continuous frames as an image period; and
displaying the first gray level Lₙ and the third gray level Lₓ by the dot respectively in the plurality of frames of the image period.

8. The hybrid frame rate control method used in a display as claimed in claim 7, wherein the image period has four continuous frames, and the dot randomly displays the first gray level Lₙ in one frame of the image period and displays the third gray level Lₓ in three frames of the image period.

9. The hybrid frame rate control method used in a display as claimed in claim 7, wherein the image period has four continuous frames, and the dot randomly displays the first gray level Lₙ in two frame of the image period and displays the third gray level Lₓ in two frames of the image period.

10. The hybrid frame rate control method used in a display as claimed in claim 7, wherein the image period has four continuous frames, and the dot randomly displays the first gray level Lₙ in three frames of the image period and displays the third gray level Lₓ in one frame of the image period.

11. The hybrid frame rate control method used in a display as claimed in claim 1 further comprising the steps of:
taking a predetermined number of continuous frames as an image period; and
displaying the second gray level Lₙ₊₁ and the third gray level Lₓ by the dot respectively in the plurality of frames of the image period

12. The hybrid frame rate control method used in a display as claimed in claim 11, wherein the image period has four continuous frames, and the dot randomly displays the second gray level Lₙ₊₁ in one frame of the image period and displays the third gray level Lₓ in three frames of the image period.

13. The hybrid frame rate control method used in a display as claimed in claim 11, wherein the image period has four continuous frames, and the dot randomly displays the second gray level Lₙ₊₁ in two frames of the image period and displays the third gray level Lₓ in two frames of the image period.

14. The hybrid frame rate control method used in a display as claimed in claim 11, wherein the image period has four continuous frames, and the dot randomly displays the second gray level Lₙ₊₁ in three frames of the image period and displays the third gray level Lₓ in one frame of the image period.

15. A dot architecture for hybrid frame rate control in a display, each dot comprising three sub-dots, and each sub-dot comprising:
a scanning line,
a data line, and
a thin film transistor, the thin film transistor comprising:
a gate electrically connected to the scanning line,
a source electrically connected to the data line, and
a drain electrically connected to a sub-dot electrode, wherein the three sub-dot electrodes have predetermined area ratios.

16. The dot architecture as claimed in claim 15, wherein the three sub-dot electrodes respectively have an area ratio of 2/4, 1/4, and 1/4.

17. The dot architecture as claimed in claim 16, wherein the two sub-dot electrodes with area ratios 1/4 and 1/4 are respectively arranged on two sides of the sub-dot electrode with an area ratio 2/4.

18. The dot architecture as claimed in claim 16, wherein the two sub-dot electrodes with area ratios 1/4 and 1/4 are both arranged on one side of the sub-dot electrode with an area ratio 2/4.
